(19) United States
(12) Patent Application Publication
(10) Pub. No.: US 2004/0136198 A1
(43) Pub. Date: Jul. 15, 2004

(54) Vehicle lamp

(76) Inventors: Frank Wimbert, Eisenach (DE); Frank Gotthardt, Eisenach (DE); Peer Quendt, Eisenach (DE); Markus Brautigam, Immelborn (DE)

Correspondence Address: SUGHRUE MION, PLLC, 2100 PENNSYLVANIA AVENUE, N.W., SUITE 800, WASHINGTON, DC, 20037, US

(21) Appl. No.: 10/728,092

(22) Filed: Dec. 5, 2003

(30) Foreign Application Priority Data
Dec. 16, 2002 (DE) 202 19 483.3

(51) Int. Cl. B60Q 1/00

(52) U.S. Cl. 362/507

(57) ABSTRACT

A vehicle lamp as for a motor vehicle includes a housing with a light exit opening closed by an elongate light cover. At least one light emitting diode is arranged in the housing laterally of the light cover, its main emission direction being substantially parallel to the longitudinal direction of the light cover. Light from the diode in the main emission direction is coupled into a light guide and is at least partially coupled out transversely with respect to said main emission direction towards the light cover. A reflector arrangement which extends at least on the side of the light guide in opposite relationship to the light cover reflects towards the light cover light coupled out therefrom in other directions than towards the light cover. The reflector arrangement includes a good heat-conducting material and is in good heat-conducting relationship with the diode to dissipate heat therefrom.

### CROSS-REFERENCES TO RELATED APPLICATIONS

This application claims the priority of German utility model application Serial No. 202 19 483.3 filed Dec. 16, 2002, the subject-matter of which is incorporated herein by reference.

### FIELD OF THE INVENTION

The invention concerns a vehicle lamp and more particularly but not exclusively a motor vehicle lamp.

### BACKGROUND OF THE INVENTION

One form of vehicle lamp which can be considered as representative of a kind of lamp, in particular for a motor vehicle, includes a housing having a light exit opening closed by an elongate light cover. At least one light emitting diode is arranged in the housing laterally of the light cover, the main emission direction thereof extending substantially parallel to the longitudinal direction of the light cover. A light guide device into which the light emitted by the at least one light emitting diode in the main emission direction is coupled provides that the light is at least partially coupled out transversely with respect to said main emission direction towards the light cover. A reflector arrangement extends at least on the side of the light guide device which is in opposite relationship to the light cover and reflects towards the light cover light which is coupled out therefrom in other directions than towards the light cover.

Such a lamp can be found for example in EP 01 123 763.3 which describes a motor vehicle side flashing lamp which is fitted into the housing of a motor vehicle external rear view mirror. As the elongate light cover is adapted in respect of its shape to the curvature of the mirror housing, it is necessary for the light from the light emitting diodes which are disposed beside one of the short ends of the light exit opening and the main direction of light emission of which extends substantially tangentially with respect to the longitudinal direction of the light cover to be guided on a correspondingly curved path. Provided for that purpose are light guides in the form of bars which extend behind the light cover in parallel relationship with same and with each other and which are curved in such a way that they pass the light which is coupled into their one end almost completely to their opposite end and there emit that light in a direction which extends substantially inclinedly rearwardly with respect to the direction of travel. Disposed between those light guide bars and arranged alternately therewith are respective strip-shaped or bar-shaped lenses, behind each of which is arranged a respective group of light emitting diodes whose light which is emitted substantially in the direction of travel is converged in a vertical direction by the associated lens and focussed into a predetermined angular region. Disposed behind the bar-shaped light guides is a vapor-deposited reflector plate which is continuous in the vertical direction and which, in the region of the light emitting diodes arranged along a horizontal line, has openings through which the respective light emitting diodes protrude. In that case each opening enlarges outwardly in a frustoconical configuration away from the associated light emitting diode in order in that way to form a respective small reflector. The components of the coupled-in light, which are not further passed to the other end by the light guide bars and which issue from the light guide bars in a direction which does not lead towards the light cover are reflected by that reflector arrangement substantially towards the light cover.

A problem with the above-discussed and other vehicle lamps in which light emitting diodes are used as the light source is that the light flux from the light emitting diodes decreases with an increasing rise in temperature. On the other hand as much light as possible is required to fulfil the lighting function.

### SUMMARY OF THE INVENTION

An object of the present invention is to provide a vehicle lamp in which the light flux given off by a light emitting diode or diodes falls off as little as possible even over a prolonged lighting duration.

A further object of the invention is to provide a motor vehicle lamp such as a flashing lamp or a brake lamp incorporating at least one light emitting diode, which can maintain an at least approximately constant level of lighting efficiency without involving major structural complication and addition.

Those objects are attained by the invention as set forth herein.

As will be seen from the description hereinafter of preferred embodiments of the invention the measures according to the invention can provide for good cooling of the light emitting diodes, which can prevent a rise in the temperature thereof and thus ensure a uniform light flux even if the light emitting diodes remain switched on without an interruption over a prolonged period of time. It will further be seen that a particular advantage of the measures according to the invention is that the cooling action can be achieved without the use of additional components and thus without a substantial increase in manufacturing costs.

Advantageous embodiments and developments of the vehicle lamp according to the invention are set forth in the appendant claims.

Further objects, features and advantages of the invention will be apparent from the description hereinafter of preferred embodiments.

### BRIEF DESCRIPTION OF THE DRAWING

FIG. 1 is a diagrammatic perspective rear view of a motor vehicle external rear view mirror in its mounting position on the driver's side, into which is incorporated a side flashing lamp according to the invention,

FIG. 2 is a view on an enlarged scale in horizontal section of part of the external rear view mirror of FIG. 1 taken along line II-II, and

FIG. 3 is a highly diagrammatic horizontal section, in the installed condition in a vehicle, through a high-set brake lamp according to the invention.

### DESCRIPTION OF PREFERRED EMBODIMENTS

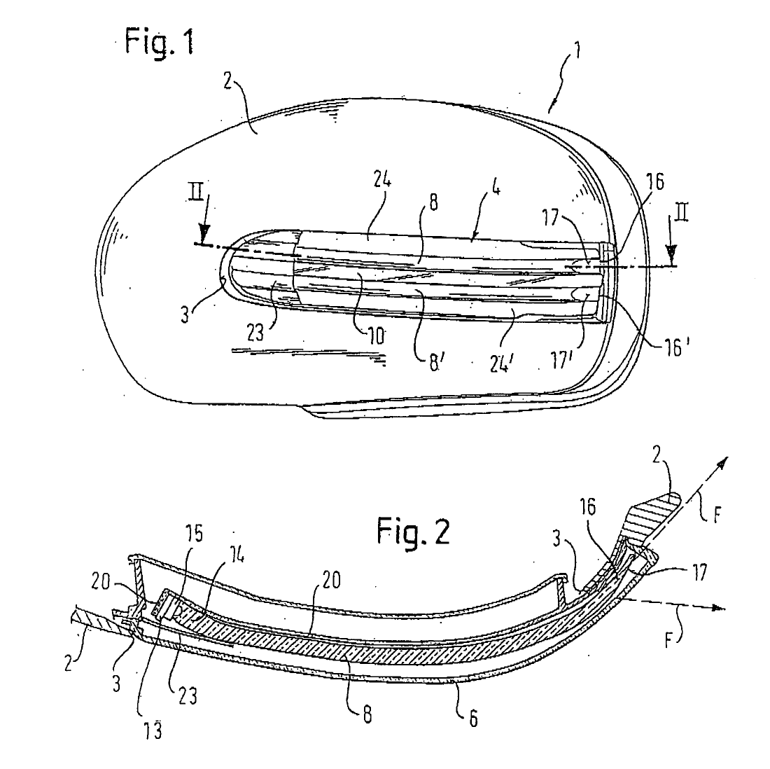

Referring firstly to FIG. 1, shown therein is a perspective view, in the opposite direction to the direction of travel, of an external rear view mirror 1 for a motor vehicle, having a housing in the form of a cover cap 2 with an elongate light exit opening 3 which in the illustrated installed condition extends substantially horizontally and into which is fitted from the rear a side flashing lamp 4 in accordance with the invention. A light cover 6 which closes the light exit opening 3 and which is optically not active, being shown in FIG. 2, is omitted from FIG. 1 for the sake of clarity.

As can be clearly seen from FIG. 1 the side flashing lamp 4 is of a strip-shaped structure. That is achieved by the provision of elongate, substantially horizontally extending regions which are alternately different in a vertical direction and which are formed by two light guides 8, 8′ which are in the form of light bars, and a strip-shaped or bar-shaped lens 10 arranged therebetween. Disposed behind the lens 10 is a group of light emitting diodes (not shown) on a line which extends substantially parallel to the lens 10. The light which is emitted substantially in the direction of vehicle travel from those light emitting diodes is caused to converge by the lens 10 in a vertical direction and is focussed into a predeterminable angular region.

As can be seen from FIG. 2, arranged at the one end, which is at the left in the Figure, of each bar-shaped light guide 8, 8′ is a further light emitting diode 15 carried on a circuit board 13 and so positioned that the light that it produces is coupled into the bar-shaped light guide 8, 8′ and passed thereby substantially to its oppositely disposed end 16, 16′. At that end 16, 16′ each of the bar-shaped light guides 8, 8′ is provided with a bevel 17, 71′ which serves as a light coupling-out surface and the inclination of which is so selected that the light issuing therethrough is emitted into the spatial angular region which is prescribed by statute, that is to say substantially transversely with respect to the direction of travel and somewhat inclinedly rearwardly, as is indicated by the arrows F.

Arranged behind the bar-shaped light guides 8, 8′ is a reflector aperture plate 20 which is continuous in a vertical direction and which is produced for example by metallic vapor deposition and which has a high level of thermal conductivity and which, at its end at the left in FIG. 2, is angularly bent over in such a way that it is in close good heat-conducting contact with the circuit board 13 carrying the light emitting diode 15, the board 13 in turn being in good heat-conducting contact with the light emitting diode 15. The above-mentioned light emitting diodes arranged in linearly mutually juxtaposed relationship behind the lens 10 have similarly good heat-conducting contact with respect to the reflector plate 20. In that way the reflector plate 20 can serve as a cooling body for all light emitting diodes of the side flashing lamp 4 designed in accordance with the invention, by virtue of enhanced dissipation of heat from the diodes.

A further important function of that reflector plate 20 may be that it catches all light which is not emitted both by the linearly mutually juxtaposed light emitting diodes and also the light guides 8, 8′ towards the light cover 6 and reflects it in such a way that it issues through the light cover 6.

At the side shown at the left in FIG. 1, the ends of the bar-shaped light guides 8, 8′ and of the lens 10, as well as transversely extending, strip-shaped regions 24, 24′ which are disposed above the upper bar-shaped light guide 8 and below the lower bar-shaped light guide 8′ are covered by a cover plate 23 which either can be metallically vapor-deposited or which can be preferably be lacquered or painted in the color of the cover cap 2 of the external rear view mirror 1, which for example is preferably the same as the color of the motor vehicle body.

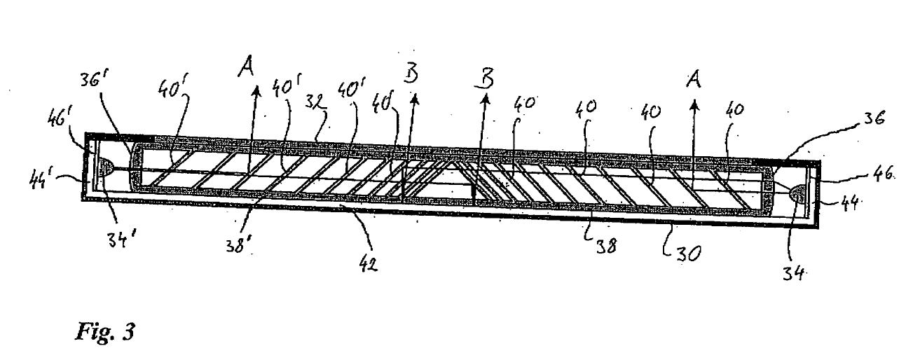

Reference will now be made to FIG. 3 to describe a vehicle lamp in accordance with the principles of the invention, in the form of a high-set brake lamp. FIG. 3 is a view in longitudinal section, which extends horizontally in the position of installation, through an elongate housing 30 of the high-set brake lamp which is designed in accordance with the invention and which is of a substantially box-shaped configuration, being closed by a light cover 32 at its front side which is upward in the Figure.

Illustrated in the interior of the housing 30 at each of the two narrow ends thereof is a light emitting diode 34, 34′, the initially divergent light beam of which passes through a Fresnel lens 36, 36′ and is thereafter propagated in the form of a substantially parallel light beam towards the oppositely disposed end.

Associated with each of the two parallel light beams is a light deflection device 38, 38′ which includes a plurality of substantially plane-parallel plates 40, 40′ of a transparent material whose refractive index differs from that of the air which fills the intermediate spaces between the plane-parallel plates 40, 40′.

The plane-parallel plates 40, 40′ are inclined with respect to the center line of the respective light beam at an angle of about 45° in such a way that a part of the light coming from the associated light emitting diode 34, 34′, which initially impinges on the front interface thereof and then on the rear interface thereof, is reflected towards the light cover 32 and passes outwardly therethrough, as is indicated by the arrows A. The part of each light beam, which is coupled out in that fashion, is in each case less than the respective proportion which, after passing through the plane-parallel plate 40, 40′ in question, is further propagated with a certain degree of parallel displacement rearwardly, that is to say away from the light cover 32, to the oppositely disposed end.

After reaching the center of the arrangement, each of the two light beams is further propagated through the light deflection device 38, 38′ which is associated with the other light beam but whose plane-parallel plates are inclined in such a way that they do not reflect the part of the light beam which does not pass therethrough in a straight line forwardly towards the light cover 32 but rearwardly. In order not to lose that part of the light beam, extending over the entire length of the brake lamp housing 30 is a reflector arrangement 42 which reflects the rearwardly coupled-out light components in such a way that, after passing through the respective plane-parallel plate 40, 40′, they go forwardly to the light cover 32 and issue therethrough, as indicated in particular by arrows B.

Due to the fact that a part of the parallel light beam is coupled out at each of the plane-parallel plates 40, 40′, the light beam becomes progressively weaker and weaker towards the center of the arrangement and the intensity of the coupled-out components of the light beam is also reduced in a corresponding fashion. In order nonetheless to achieve illumination of the light cover 32 over its entire length, which appears uniform at least to the human eye, the spacings between the individual plane-parallel plates 40, 40′ progressively decrease with increasing distance from the associated light emitting diodes 36, 36′. That arrangement provides that, in the immediate proximity of each light emitting diodes 36, 36′, per unit of length in the longitudinal direction, the light components which are coupled out are admittedly fewer but as a counterpart they are brighter, while in the proximity of the center, more light components of lesser intensity are coupled out, thus overall giving the desired uniform illumination effect at the light cover 32.

As in the case of the embodiment set out with reference to FIGS. 1 and 2, in this case also the reflector arrangement 42 is formed by a body which is a good conductor of heat and comprises either a plate chromium-plated on the reflection side or a plastic component with a suitable chromium layer applied thereto by vapor deposition. At its two ends the heat-conducting body has limbs 44, 44′ which are disposed at a right angle there and which are in close, good heat-conducting contact with the carrier circuit board 46, 46′ of the respective light emitting diode 34, 34′. The boards 46, 46′ in turn are in good heat-conducting contact with the associated light emitting diode 34 and 34′ respectively so that the reflector arrangement serves at the same time as a cooling body for the light emitting diodes 34, 34′.

In order to save on an additional component part, it is particularly advantageous for the reflector arrangement 42 to be produced in the form of mirroring which is applied directly to the insides of the rear wall and the two end walls of the housing 30.

In the case of brake lamps which are of greater extent perpendicularly to the plane of the drawing in FIG. 3, it is possible for a plurality of light emitting diodes to be arranged one above the other on each of the two ends. It is also possible for a plurality of light emitting diodes to be provided in mutually juxtaposed relationship in the plane of the drawing at each end.

It will be appreciated that the above-described embodiments of the invention have been set forth solely by way of example and illustration of the invention and various modifications and alterations may be made thereto without thereby departing from the spirit and scope of the invention.

It will further be noted that the reference numerals in the appended claims are included to facilitate understanding of the claims and do not represent a limitation on the scope of the invention.

What is claimed is:

1. A vehicle lamp including
a housing having a light exit opening (3)
an elongate light cover (6; 32) closing the light exit opening,
at least one light emitting diode in the housing laterally of the light cover (6; 32), the light emitting diode having a main emission direction substantially parallel to the longitudinal direction of the light cover (6; 32),
a light guide device (8, 8′; 38, 38′) positioned for light emitted by the at least one light emitting diode (15; 34, 34′) in the main emission direction to be coupled into the light guide device and at least partially coupled out transversely with respect to said main emission direction towards the light cover (6; 32), and
a reflector arrangement (20; 42) which extends at least on the side of the light guide device (8, 8′; 38, 38′) in opposite relationship to the light cover (6; 32) and reflects towards the light cover (6; 32) light which is coupled out therefrom in other directions than towards the light cover (6; 32), the reflector arrangement (20; 42) including a good heat-conducting material and being in good heat-conducting relationship with the at least one light emitting diode (15; 34, 34′) to act for same as a cooling means.

2. A vehicle lamp as set forth in claim 1 including
a carrier circuit board (13; 46, 46′) on which the at least one light emitting diode (15; 34, 34′) is mounted in good heat-conducting contact therewith, the circuit board in turn being in good heat-conducting contact with the reflector arrangement (20; 42).

3. A vehicle lamp as set forth in claim 1
wherein the reflector arrangement (20; 42) includes a plate with a high mirror finish vapor deposited thereon.

4. A vehicle lamp as set forth in claim 1
wherein the reflector arrangement (20; 42) includes a chromium-plated plastic body.

5. A vehicle lamp as set forth in claim 1
wherein the reflector arrangement is formed by at least one housing wall having an inside surface with a reflective layer thereon.

6. A vehicle lamp as set forth in claim 1
in the form of a side flashing lamp (4) for fitting into the housing of an external rear view mirror (1).

7. A vehicle lamp as set forth in claim 1
in the form of a high-set brake lamp.
